(19) United States
(12) Patent Application Publication
(10) Pub. No.: US 2023/0206186 A1
(43) Pub. Date: Jun. 29, 2023

(54) FRIED FOOD DISPOSAL TIME MANAGEMENT DEVICE, FRIED FOOD DISPOSAL TIME MANAGEMENT SYSTEM, AND FRIED FOOD DISPOSAL TIME MANAGEMENT METHOD

(71) Applicant: J-OIL MILLS, Inc., Tokyo (JP)

(72) Inventors: Kenichi KAKIMOTO, Tokyo (JP); Ryohei WATANABE, Tokyo (JP); Masami INOUE, Tokyo (JP)

(21) Appl. No.: 17/927,945

(22) PCT Filed: May 26, 2021
(86) PCT No.: PCT/JP2021/019950

§ 371 Date: Nov. 28, 2022

(30) Foreign Application Priority Data
Jun. 9, 2020 (JP) 2020-100255

(51) Int. Cl. G06Q 10/109; A47B 77/08

(52) U.S. Cl. CPC G06Q 10/109; A47B 77/08

(57) ABSTRACT

Provided is a fried food disposal time management device for improving the accuracy of management of the time to dispose a fried food being displayed in a display cabinet. A fried food disposal time management device 4 for managing a time to dispose a fried food X being displayed in a hot showcase 1 includes: a data acquisition unit 41 that acquires data on a condition of the fried food X; a determination unit 44 that determines whether the time to dispose the fried food X is reached based on the condition of the fried food acquired by the data acquisition unit 41 and a determination reference; and a notification unit 46 that outputs, when the determination unit 44 makes a determination result that the time to dispose the fried food X is reached, a notification signal for notifying the determination signal to a monitor 308.

### TECHNICAL FIELD

The present invention relates to a fried food disposal time management device, a fried food disposal time management system, and a fried food disposal time management method, which are provided to manage the time to dispose fried foods displayed in a display cabinet.

### BACKGROUND ART

In recent years, in stores such as convenience stores and supermarkets, fried foods cooked in fryers installed in the stores are offered to customers. Such fried foods are displayed, for example, in hot showcases (also referred to as hot food display cases, food warmer, warming cabinets, or the like) which are display cabinets having keep warm function. The hot showcases have functions to manage the conditions in display spaces in order to allow the fried foods to be displayed therein while maintaining conditions thereof suitable for sale. Patent Literature 1 discloses an in-compartment temperature setting device for a showcase that can set or change the in-compartment temperature of the hot showcase to the temperature suitable for foods displayed therein based on information such as a temperature range for preserving the displayed food and an optimum temperature range for offering it to customers.

There have been various management indicators for maintaining the quality of fried foods displayed in a display cabinet including a hot showcase. Among these management indicators, an indicator of “elapsed time after finishing of deep-frying” has been known as a management indicator that can be easily measured. It is commonly known that the flavor of fried foods decreases over time.

Based on the technique disclosed in Patent Literature 1, even if the temperature in the hot showcase is controlled to be a temperature suitable for fried foods, the fried foods which kept displayed in the hot showcase for a long time are not suitable for sale due to loss of flavor. In view of the above, it is demanded to determine when to stop selling the fried foods displayed in a hot showcase based on the elapsed time.

In order to appropriately manage when to stop selling the fried foods after the finishing of deep-frying thereof, in other words, the time to dispose the fried foods, an employee of a store has to record the time of finishing of deep-frying, measure the elapsed time from the recorded time, and determine whether the measured elapsed time exceeds a reference time in a timely manner so as not to miss the time to dispose.

### CITATION LIST

### Patent Literature

Patent Literature 1: JP-A-2005-83602

### SUMMARY OF INVENTION

### Technical Problem

However, in the case of manual operation by an employee of a store, the employee may often make mistakes, for example, erroneously record the time of finishing of deep-frying, or erroneously measure the elapsed time from the finishing of deep-frying. Furthermore, in many cases, various kinds of fried foods which have been deep-fried in various ways are displayed in a display cabinet, and thus manually managing the time to dispose which is suitable for each of the various kinds of fried foods by an employee of a store is complicated and easily leads to mistakes. Thus, managing the time to dispose of the fried foods based on the manual operation by an employee of a store may cause a problem, in particular, in view of accuracy.

Therefore, an object of the present invention is to provide a fried food disposal time management device, a fried food disposal time management system, and a fried food disposal time management method, which improve the accuracy of management of the time to dispose a fried food being displayed in a display cabinet.

### Solution to Problem

In order to achieve the object described above, the present invention provides a fried food disposal time management device for managing a time to dispose a fried food to be displayed in a display cabinet, the fried food disposal time management device comprising: a data acquisition unit that acquires data output from a condition sensor configured to detect a condition of the fried food being displayed in the display cabinet; a determination unit that determines whether the time to dispose the fried food being displayed in the display cabinet is reached based on the condition of the fried food acquired as the data by the data acquisition unit and a determination reference set in advance as a reference for determining the time to dispose the fried food; and a notification unit that outputs, when the determination unit makes a determination result that the time to dispose the fried food being displayed in the display cabinet is reached, a notification signal for notifying the determination result to a notification device.

### Advantageous Effects of Invention

According to the present invention, it is possible to improve the accuracy of management of the time to dispose a fried food being displayed in a display cabinet. The problems, configurations, and advantageous effects other than those described above will be clarified by explanation of the embodiments below.

### BRIEF DESCRIPTION OF DRAWINGS

FIG. 1 is a perspective view illustrating a configuration example of a hot showcase.

FIG. 2 illustrates a graph showing the change in the deteriorated flavor obtained by sensory evaluation with respect to the elapsed time.

FIG. 3 is a system configuration diagram illustrating a configuration example of a fried food disposal time management system.

FIG. 4 is a configuration diagram illustrating a hardware configuration example of a fried food disposal time management device.

FIG. 5 illustrates a graph showing the change in the color density of a fried food obtained by sensory evaluation with respect to the elapsed time.

FIG. 6 is a plan view of the inside of the hot showcase as viewed from the rear side thereof.

FIG. 7 illustrates graphs showing the change in color components, which are obtained by capturing still images of a fried chicken being displayed in a hot showcase and analyzing the captured still images, with respect to the elapsed time.

FIG. 8 illustrates graphs showing the change in color components, which are obtained by capturing moving images of a fried chicken being displayed in a hot showcase and analyzing the captured moving images, with respect to the elapsed time.

FIG. 9 illustrates graphs showing the change in color components, which are obtained by capturing still images of a croquette being displayed in a hot showcase and analyzing the captured still images, with respect to the elapsed time.

FIG. 10 illustrates graphs showing the change in color components, which are obtained by capturing moving images of a croquette being displayed in a hot showcase and analyzing the captured moving images, with respect to the elapsed time.

FIG. 11 is a functional block diagram illustrating the functions of the fried food disposal time management device.

FIG. 12 is a flowchart illustrating a flow of processing executed by the fried food disposal time management device.

FIG. 13 is a diagram illustrating a display example of a monitor.

FIG. 14 illustrates a graph showing the change in the stickiness of fried food batter, which is obtained by sensory evaluation, with respect to the elapsed time.

FIG. 15 is a plan view of a bottom surface of a certain stage in a hot showcase as viewed from above.

FIG. 16 illustrates a graph showing the change in the intensity of smell of a fried food, which is obtained by sensory evaluation, with respect to the elapsed time.

FIG. 17 is a top view of a portion corresponding to a top face of a certain stage in a hot showcase as viewed from below, which illustrates a plurality of smell sensors attached to the top face portion.

FIG. 18 is a top view of a portion corresponding to a top face of a certain stage in a hot showcase as viewed from below, which illustrates a plurality of near-infrared sensors attached to the top face portion.

FIG. 19 illustrates a graph showing the temporal change in the moisture content in batter on a front surface of a fried chicken being displayed in a hot showcase.

FIG. 20 illustrates a graph showing the temporal change in the crisp texture of a fried chicken being displayed in a hot showcase.

FIG. 21 illustrates graphs showing the change in color components, which are obtained by capturing still images of a fried chicken being displayed in a hot showcase and analyzing the captured still images, with respect to the elapsed time.

FIG. 22 illustrates a graph showing the change in an average area, which is obtained by capturing still images of three pieces of fried chickens being displayed in a hot showcase and analyzing the captured still images, with respect to the elapsed time.

### DESCRIPTION OF EMBODIMENTS

A fried food disposal time management system according to each embodiment of the present invention is a system for managing the time to dispose fried foods (for example, fried chickens, croquettes, french fries, and the like) displayed in a display cabinet such as a hot showcase, which is installed near a check-out area in a small-scale store such as a convenience store, or a showcase installed in a prepared meal department (grocery department) in a supermarket and the like.

### Configuration of Hot Showcase 1

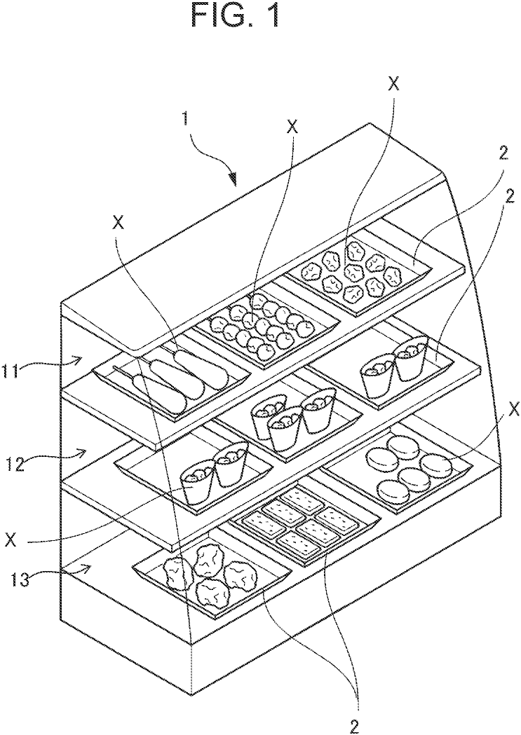

Firstly, a configuration example of a hot showcase 1, which is an aspect of a display cabinet, will be described with reference to FIG. 1.

FIG. 1 is a perspective view illustrating a configuration example of the hot showcase 1.

The hot showcase 1 is an example of a display cabinet for fried foods, which is installed in a store such as a convenience store and in which fried foods cooked in the store are displayed. A space inside the hot showcase 1, that is, a display space in which the fried foods are displayed, is kept at a suitable temperature allowing the display environment of the fried foods to be maintained under a suitable condition, and is managed so that the fried foods under preferable conditions can be offered to customers.

FIG. 1 illustrates the hot showcase 1 provided with three floors 11, 12, 13, and a plurality of types of fried food X is displayed on each of the floors 11, 12, 13. The plurality of fried food X is arranged in such a manner that the same type of pieces of fried food X are placed in the same tray 2. In FIG. 1, each of the floors 11, 12, 13 is provided with the three trays 2. In the following, in order to distinguish the floors 11, 12, 13 from each other, the floor on the uppermost stage of the hot showcase 1 is referred to as the first stage floor 11, the floor on the middle stage is referred to as the second stage floor 12, and the floors on the lowermost stage is referred to as the third stage floor 13.

### Overall Configuration of Fried Food Disposal Time Management System 3

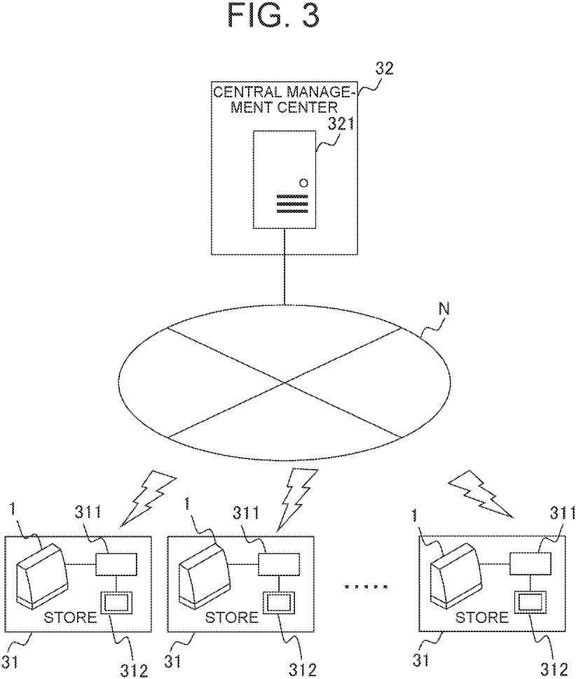

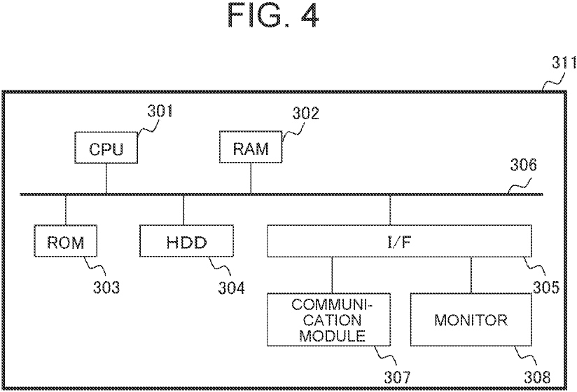

Next, an overall configuration of the fried food disposal time management system 3 will be described with reference to FIG. 3 and FIG. 4.

FIG. 3 is a system configuration diagram illustrating a configuration example of the fried food disposal time management system 3. FIG. 4 is a configuration diagram illustrating a hardware configuration example of a fried food disposal time management device 4.

As illustrated in FIG. 3, the fried food disposal time management system 3 includes controllers 311 installed, respectively, in stores 31 which are, for example, members of a convenience store chain, and a management server 321 installed in a central management center 32 that controls the stores 31. Each of the controllers 311 and the management server 321 are directly or indirectly connected to each other so as to be capable of information communication therebetween via a communication network N such as an Internet communication line.

Each of the controllers 311 is configured to execute processing such as management of the hot showcase 1 and management of devices provided in the store 31. The management server 321 is configured to mainly execute processing such as sales management of each of the stores 31.

In FIG. 3, it is assumed that each of the hot showcases 1 is connected to each of the corresponding controllers 311 so as to be able to communicate therebetween. In this case, the means for communication may be wired or wireless. Each of the hot showcases 1 can have a function to, upon detecting condition of the fried food X being displayed on each of the floors 11, 12, 13, transmit the detected information to the management server 321 via each of the corresponding controllers 311. At this time, each of the hot showcases 1 may transmit the information indicating the condition of the fried food X to the management server 321 by direct communication without relaying the information to each of the corresponding controller 311.

As illustrated in FIG. 4, each of the controllers 311 includes a CPU (Central Processing Unit) 301, a RAM (Random Access Memory) 302, a ROM (Read Only Memory) 303, an HDD (Hard Disk Drive) 304, and an I/F (Interface) 305. These elements are connected to each other via a common bus 306.

The CPU 301 is an arithmetic unit, and controls the entire operations of the controller 311. The RAM 302 is a volatile storage medium capable of reading and writing information at high speed, and is used, for example, as a work area where the CPU 301 executes the image information processing. The ROM 303 is a read-only nonvolatile storage medium, and retains programs such as a firmware.

The HDD 304 is a nonvolatile storage medium capable of reading and writing information and has a large storage capacity. The HDD 304 retains an OS (Operating System), control programs and application programs for executing various kinds of information processing which will be described later, and the like. Note that the HDD 304 may be substituted by a device which realizes functions of storing and managing information as a nonvolatile storage medium regardless of the type of device, and for example, such a device may be an SSD (Solid State Drive).

The I/F 305 is a connection interface with the communication network N, to which a communication module 307 that realizes information communication with other devices such as sensors, a monitor 308 for displaying a user interface, and the like are connected.

Specifically, the monitor 308 visualizes and provides a management status of the hot showcase 1, condition of the fried food X being displayed in the hot showcase 1, and the like, and is installed, for example, near the hot showcase 1. The monitor 308 is an aspect of a notification device that notifies that the fried food X being displayed in the hot showcase 1 needs to be disposed.

Each of the controllers 311 having the hardware configuration described above is an information processing device that realizes, by an arithmetic function provided in the CPU 301, processing functions of the control programs stored in the ROM 303, the control programs and application programs loaded from a storage medium such as the HDD 304 into the RAM 302. The information processing described above is executed, thereby configuring a software control unit including various functional modules of each of the controllers 311. Combination of the software control unit configured as described above and hardware resources including the configurations as described above configures the functional blocks that realize the functions of each of the controllers 311.

The management server 321 also has a hardware configuration similar to that of each of the controllers 311. The control programs and application programs stored in a storage medium provided in each of the configurations are executed, thereby configuring the functional blocks that realize the functions of the management server 321.

The fried food disposal time management device 4 is configured to execute the specific information processing for managing the time to dispose the fried food X being displayed in the hot showcase 1. All the functions of the fried food disposal time management device 4 may be implemented in a store software provided in each of the controllers 311 or in a central management software provided in the management server 321, or the functions thereof may be distributed between the store software and the central management software and then implemented therein.

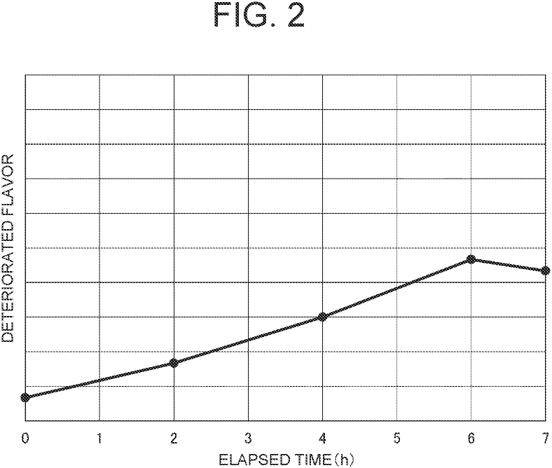

Here, the deterioration of flavor of the fried food X being displayed in the hot showcase 1 will be described with reference to FIG. 2.

FIG. 2 is a graph illustrating the change in the deteriorated flavor of a fried food obtained by sensory evaluation with respect to the elapsed time.

In FIG. 2, the horizontal axis represents the elapsed time after the finishing of deep-frying of a fried food to be evaluated, and the vertical axis represents the “deteriorated flavor”. The “deteriorated flavor” expresses how much the fried food is deteriorated, which is obtained by converting the flavor of the fried food into a predetermined evaluation point and using the accumulated value of the point. That is, if the value of the deteriorated flavor is low, it is estimated that the fried food is less deteriorated and a suitable condition has been maintained. On the other hand, if the value of the deteriorated flavor is high, it is estimated that the fried food has been deteriorated and thus the time to dispose the fried food is approaching. Thus, it is possible to determine whether the time to dispose the fried food is reached based on whether the deteriorated flavor exceeds a predetermined threshold value.

As illustrated in FIG. 2, in general, the more the time passes after the finishing of deep-frying of a fried food, the more the flavor thereof deteriorates (the level of deterioration of flavor increases). That is, based on FIG. 2, it can be considered that the flavor of a fried food decreases over time. It can be estimated that, among the plurality of pieces of fried food X being displayed in the hot showcase 1, the flavor of the one placed for a predetermined period of time after the finishing of deep-frying thereof deteriorates and is not suitable for sale to customers. Thus, when a predetermine time after the finishing of deep-frying of a fried food is reached, the fried food is subject to disposal.

In view of the above, the fried food disposal time management device 4 manages the time to dispose the fried food X based on indicators that change in accordance with the deterioration of flavor of the fried food X. The indicators used for the management of the time to dispose are the ones that have been confirmed to have the functions to determine the condition of the fried food X. For example, the indicators include the color tone, size, moisture content, amount of volatile components, composition of volatile components, acid value, anisidine value, carbonyl value, peroxide value, iodine value, and amount of polar compounds of the fried food X. Hereinafter, the configuration of the fried food disposal time management system 3 using each of the indicators will be described for each embodiment.

### First Embodiment

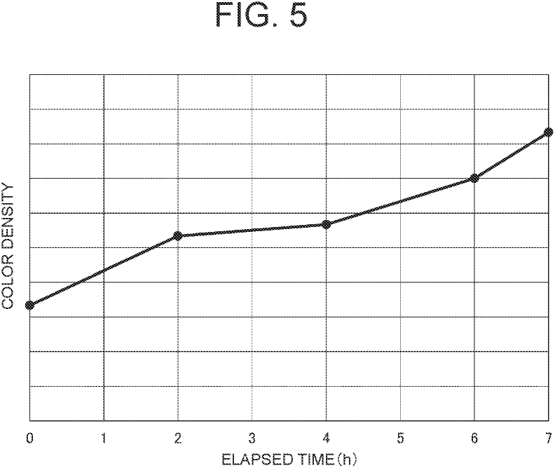

The fried food disposal time management system 3 according to a first embodiment will be described with reference to FIG. 5 to FIG. 13.

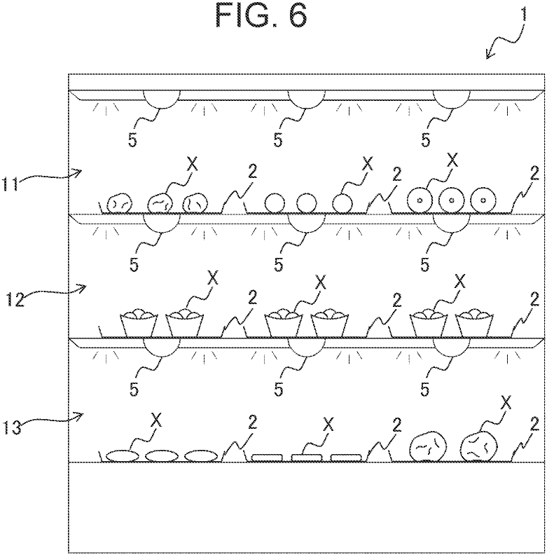

FIG. 5 is a graph illustrating the change in the color density of a fried food obtained by sensory evaluation with respect to the elapsed time. FIG. 6 is a plan view of the inside of the hot showcase 1 as viewed from the rear side thereof.

In FIG. 5, the horizontal axis represents the elapsed time after the finishing of deep-frying of a fried food to be evaluated, and the vertical axis represents a value obtained by indexing the “color density” of the fried food.

As illustrated in FIG. 5, in the case of a fried food, the more the time passes after the finishing of deep-frying thereof, the more a value of the indicator indicating the color density of a fried food surface increases. That is, the color of the fried food surface tends to get darker over time. Here, a value of the “deteriorated flavor” illustrated in FIG. 2 also increases as the time passes after the finishing of deep-frying. Thus, there is a correlation between the color density of a fried food surface and the deterioration of flavor of a fried food.

In view of the above, in the present embodiment, the fried food disposal time management device 4 uses the color tone of the fried food X being displayed in the hot showcase 1 as an indicator indicating the condition of the fried food X so as to determine whether the time to dispose the fried food X is reached based on the change in the color tone of the fried food X.

In the present embodiment, as illustrated in FIG. 6, cameras 5 capable of capturing still images and moving images are used as condition sensors for detecting the conditions of the fried food X being displayed in the hot showcase 1. The fried food disposal time management device 4 identifies a surface image of each of pieces of fried food X from the still images or moving images captured by the cameras 5, calculates RGB values of pixels which are components of the surface image, and analyzes the calculated RGB values as color components of each of the pieces of fried food X.

The method of analyzing the color of each of the pieces of fried food X does not necessarily have to be the method based on RGB values. As an example of other analysis methods, wavelengths of the still images or moving images captured by the cameras 5 may be analyzed. In the case of using the moving images, extracting still images from the moving images at predetermined sampling times and using the still images as analysis targets enables analysis of the color components of each of the pieces of fried food X for each predetermined elapsed time.

In FIG. 6, the plurality of cameras 5 is mounted in the hot showcase 1 so as to acquire images of each of the pieces of fried food X being displayed on each of the floors 11, 12, 13. For example, each of the cameras 5 is attached to the top face at the portion facing the center of each of the trays 2. However, the mounting positions of the cameras 5 and the number thereof are not particularly limited thereto as long as they are positioned such that all pieces of fried food X being displayed in the hot showcase 1 can be included in the angle of view thereof. Each of the cameras 5 does not necessarily have to be cameras capable of capturing both still images and moving images, but may be the ones capable of capturing only still images such as still cameras.

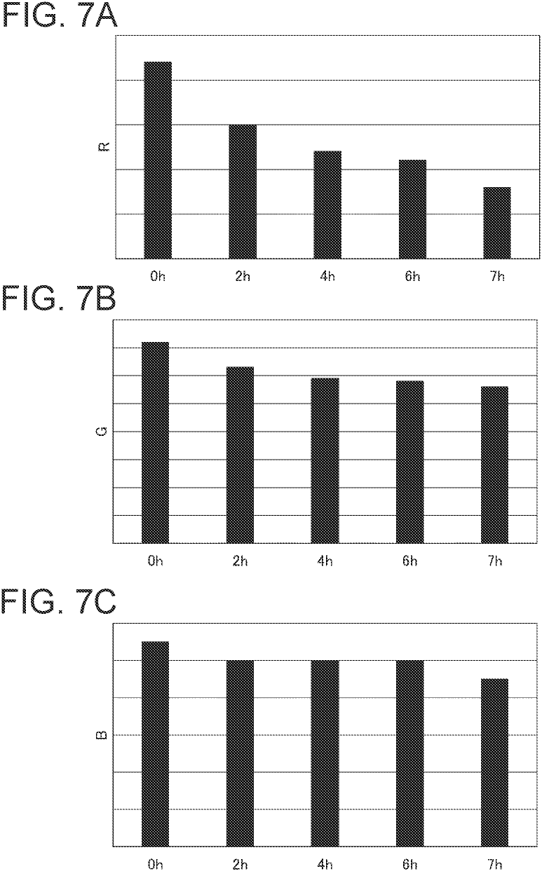

Next, an example of temporal trends of the “color density” of the fried food X experimentally confirmed by the Applicant, obtained by analyzing each color component (R, G, and B) using images similar to the images of the fried food X obtained by the cameras 5 will be described with reference to the graphs illustrated in FIGS. 7 to 10.

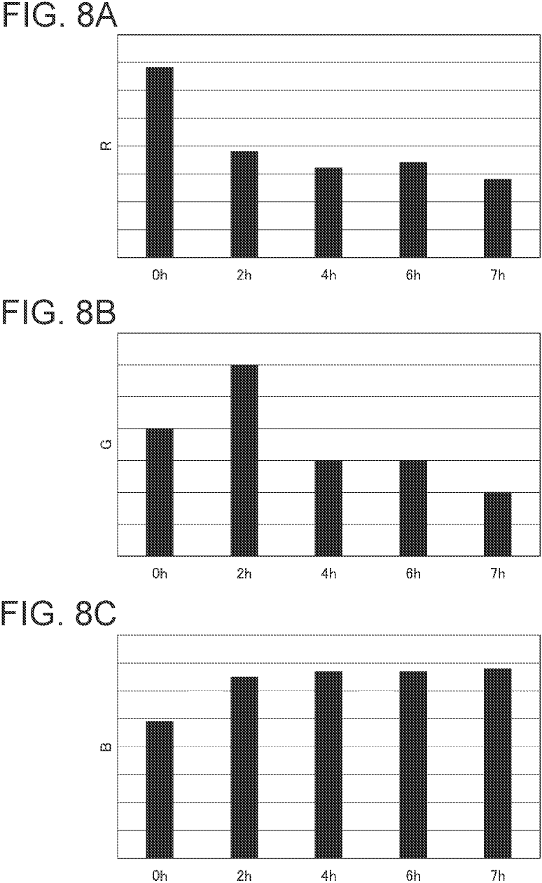

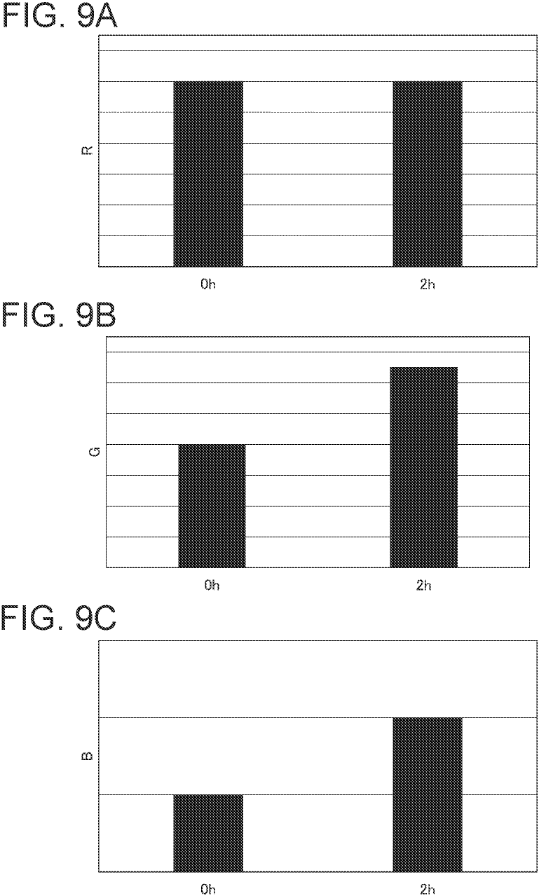

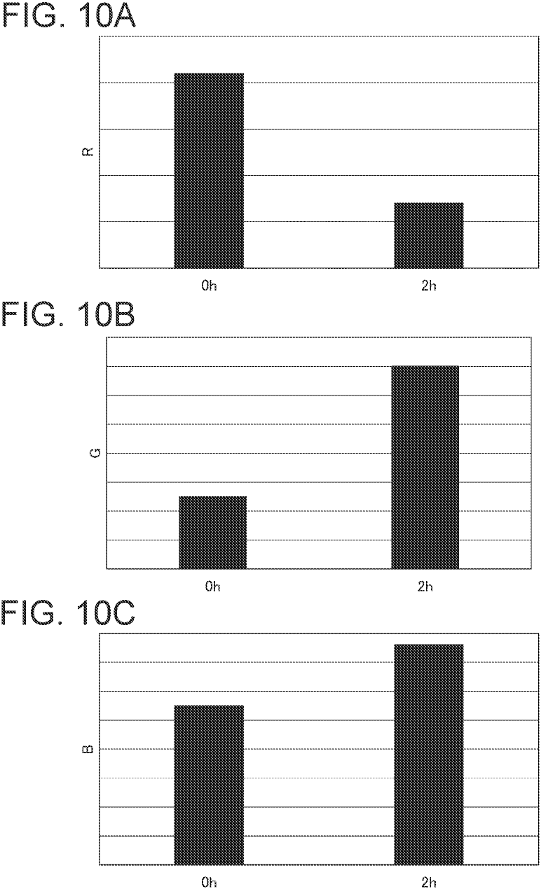

FIG. 7A, FIG. 8A, FIG. 9A, and FIG. 10A illustrate a trend of the component R with respect to the elapsed time, FIG. 7B, FIG. 8B, FIG. 9B, and FIG. 10B illustrate a trend of the component G with respect to the elapsed time, and FIG. 7C, FIG. 8C, FIG. 9C, and FIG. 10C illustrate a trend of the component B with respect to the elapsed time, respectively.

FIG. 7A to FIG. 7C are graphs illustrating the change in color components, which are obtained by capturing still images of a fried chicken being displayed in the hot showcase 1 and analyzing the captured still images, with respect to the elapsed time.

As illustrated in FIG. 7A to FIG. 7C, based on the analysis of the color components from the still images of the fried chicken being displayed in the hot showcase 1, it is found that all the components R, G, and B decrease after two hours (=2 h) from the finishing of deep-frying thereof (=0 h) . As four hours, six hours, and then seven hours pass from the finishing of deep-frying, all the components R, G, and B tend to decrease as a whole.

FIG. 8A to FIG. 8C are graphs illustrating the change in color components, which are obtained by capturing moving images of the fried chicken being displayed in the hot showcase 1 and analyzing the captured moving images, with respect to the elapsed time.

As illustrated in FIG. 8A to FIG. 8C, based on the analysis of the color components from the moving images of the fried chicken being displayed in the hot showcase 1, it is found that the component R decreases after two hours (=2 h) from the finishing of deep-frying thereof (=0 h) while the components G and B increase.

In the same manner as the analysis of the color components from the still images of the fried chicken, it is found that the component R decreases as a whole as four hours, six hours, and then seven hours pass from the finishing of deep-frying. On the other hand, it is found that the component G obtained after four hours from the finishing of deep-frying decreases as compared with the content obtained immediately after the finishing of deep-frying thereof and that obtained after two hours from the finishing of deep-frying, and further decreases after seven hours from the finishing of deep-frying. Furthermore, the component B tends to slightly increase as a whole as the time passes from the finishing of deep-frying to four hours, six hours, and then seven hours.

FIG. 9A to FIG. 9C are graphs illustrating the change in color components, which are obtained by capturing still images of a croquette being displayed in the hot showcase 1 and analyzing the captured still images, with respect to the elapsed time.

As illustrated in FIG. 9A to FIG. 9C, based on the analysis of the color components from the still images of the croquette being displayed in the hot showcase 1, it is found that the component R does not change after two hours (=2 h) from the finishing of deep-frying thereof (=0 h) while the components G and B increase.

FIG. 10A to FIG. 10C are graphs illustrating the change in color components, which are obtained by capturing moving images of the croquette being displayed in the hot showcase 1 and analyzing the captured moving images, with respect to the elapsed time.

As illustrated in FIG. 10A to FIG. 10C, based on the analysis of the color components from the moving images of the croquette being displayed in the hot showcase 1, it is found that the component R decreases after two hours (=2 h) from the finishing of deep-frying thereof (=0 h) while the components G and B increase in the same manner as the analysis of the color components from the still images of the croquette.

In view of the above, for the fried food X being displayed in the hot showcase 1, based on the tendency of the change in the color tone with the elapsed time from the finishing of deep-frying thereof (particularly, in the case of fried chickens and croquettes, it appears remarkably after two hours from the finishing of deep-frying), a reference value (reference RGB values) for determining the time to dispose the fried food X can be set in advance.

Note that the determination reference value may be set to a predetermined value evenly to every piece of fried food X regardless of their type, or may be set to a different value for each type of the fried food X. For example, as illustrated in FIG. 8 and FIG. 10, based on the analysis of the color components from the moving images, the same tendency (R decreases but G and B increase) is found both in the fried chicken and the croquette, however, based on the analysis of the color components from the still images, the tendency which differs between the fried chicken and the croquette (in the case of the fried chicken, all of R, G, and B decrease while, in the case of the croquette, R does not change but G and B increase) is found.

Thus, the reference value may be set to a predetermined value regardless of the type of the fried food X in the case of analyzing the color components in the still image. However, in the case of analyzing the color components in the moving images, setting the reference value to a different value for each type of the fried food X enables the fried food disposal time management device 4 to accurately determine the time to dispose.

### Functional Structure of Fried Food Disposal Time Management System 4

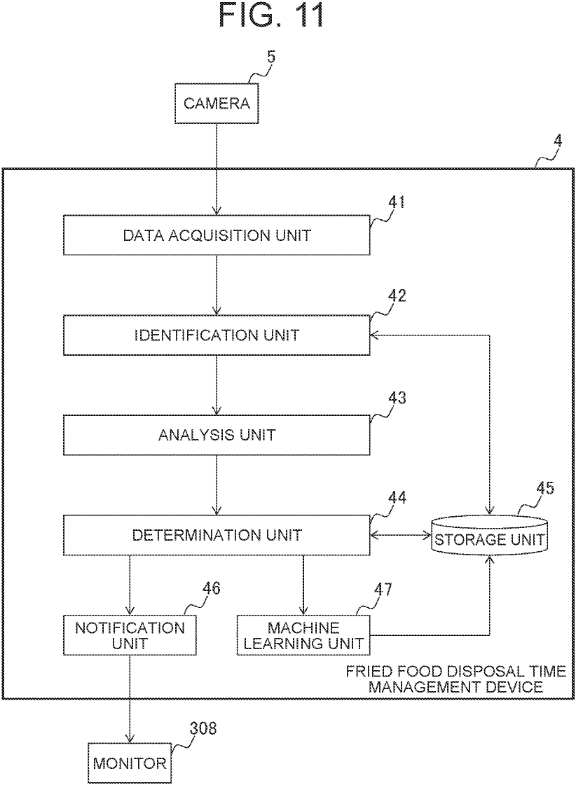

Next, the functional configuration of the fried food disposal time management device 4 will be described with reference to FIG. 11 to FIG. 13.

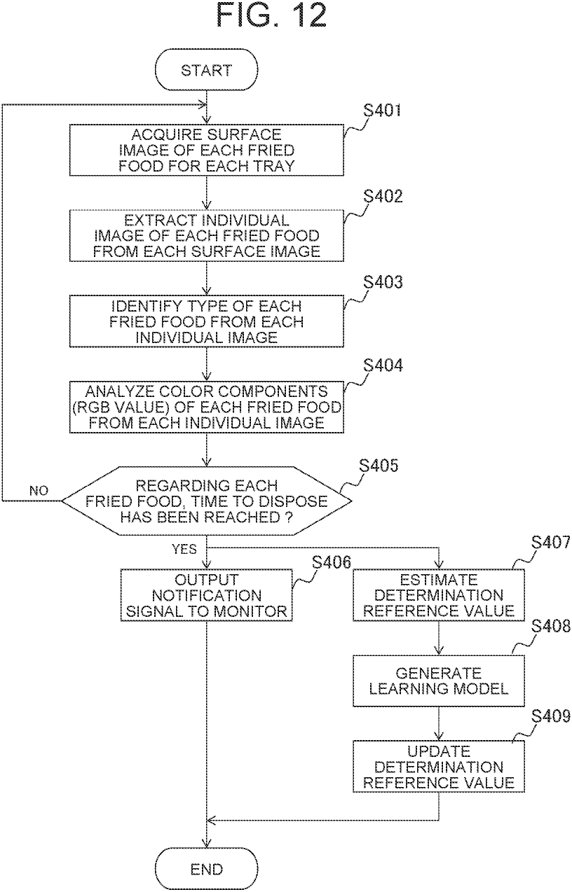

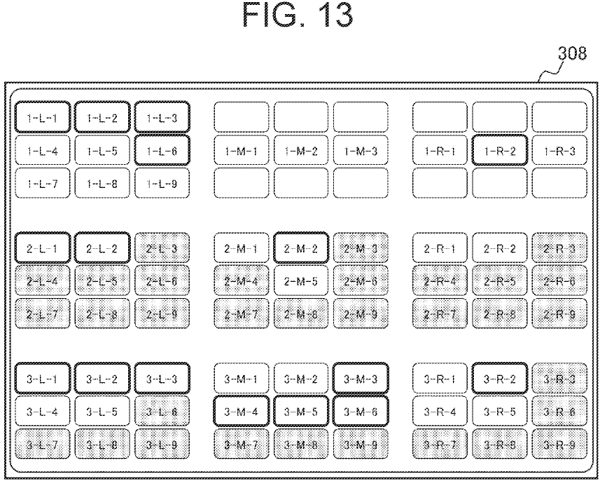

FIG. 11 is a functional block diagram illustrating the functions of the fried food disposal time management device 4. FIG. 12 is a flowchart illustrating a flow of processing executed by the fried food disposal time management device 4. FIG. 13 is a diagram illustrating a display example of the monitor 308.

The fried food disposal time management device 4 includes, for example, a data acquisition unit 41, an identification unit 42, an analysis unit 43, a determination unit 44, a storage unit 45, a notification unit 46, and a machine learning unit 47.

The data acquisition unit 41 acquires, based on surface images (still images or moving images) of the plurality of pieces of fried food X for each of the trays 2 captured by each of the cameras 5, data related to the color tone of each piece of fried food X. For example, the image processing for extracting the outline form of each of the pieces of fried food X included in the images captured by each of the cameras 5, thereby identifying an image region of each of the pieces of fried food X. Next, an analysis region composed of a predetermined group of pixels is identified from the identified image region, thereby obtaining the components R, G, and B of each of the pixels included in the identified analysis region.

Note that the components R, G, and B of each of the pixels may be acquired by the analysis unit 43. The analysis region does not have to be based on the size of the image region of each of the pieces of fried food X, but may be set by a predetermined number of pixels, or may be identified by the pixels sampled at a fixed ratio with respect to the number of pixels included in the image region.

The identification unit 42 identifies the type of each of the pieces of fried food X from an individual image thereof extracted from the surface images acquired by the data acquisition unit 41. The identification unit 42 compares the individual image of each of the pieces of the fried food X with a sample image which is a reference for identification. The sample image is stored in the storage unit 45. For example, when the monitor 308 has a function as an input terminal, the identification unit 42 can be configured to identify the type of each of the pieces of fried food X based on the type which has been manually input by an employee of the store through the monitor 308.

Note that the fried food disposal time management device 4 does not necessarily have to include the identification unit 42. When the reference value for determining the time to dispose the fried food X is set to a predetermined value regardless of the type of the fried food X, it is not necessary to provide the identification unit 42.

The analysis unit 43 analyzes the color components (RGB values) of each of the pieces of fried food X from each of the individual images. The determination unit 44 determines whether the time to dispose each of the pieces of fried food X is reached based on the color components of each of the pieces of fried food X analyzed by the analysis unit 43, the type of each of the pieces of fried food X, and the determination reference values set for each type of the fried food X. The determination reference values are stored in the storage unit 45. In the present embodiment, since the color components (color tone) are used as an indicator for managing the time to dispose, the determination reference values are set to the ones related to the color components. However, in the case of using another one of the indicators, the determination reference values are set to the ones related to the selected indicator.

Note that when the determination reference values are set to predetermined values regardless of the type of the fried food X, the determination unit 44 determines whether the time to dispose the fried food X is reached based on the color components of each of the pieces of fried food X analyzed by the analysis unit 43 and the determination reference values.

When the determination unit 44 determines that, regarding any piece of fried food X, the time to dispose it is reached, the notification unit 46 outputs, to the monitor 308, a notification signal for notifying, as a determination result, information identifying the piece of fried food X as determined. The notification unit 46 may be configured to output, in addition to the information indicating that the time to dispose is reached, the type of the indicator related to the determination that the piece of fried food X should be disposed, the numerical value of the indicator, and the like, as the determination result. The information (signal) output by the notification unit 46 is not limited to the specific type and expression or notification format as long as it is the information capable of prompting an employee of the store to dispose the fried food X.

Based on the notification signal from the notification unit 46, the monitor 308 visualizes and provides the condition related to the disposal of the piece of fried food X being displayed in the hot showcase 1. For example, as illustrated in FIG. 13, the monitor 308 shows a display structure of the first stage floor 11 of the hot showcase 1, that of the second stage floor 12, and that of the third stage floor 13 from the top.

The display structures of the floors 11, 12, 13 on the screen of the monitor 308 illustrated in FIG. 13 correspond to the display structures of the floors 11, 12, 13 illustrated in FIG. 6, respectively. For example, on the screen of the monitor 308 illustrated in FIG. 13, the numbers 1-R-1, 1-R-2, 1-R-3 are assigned to the three pieces of fried food X (corn dogs) placed on the tray 2 in the right row of the first floor 11 illustrated in FIG. 6. There is no particular limitation on how the number is provided to each of the pieces of fried food X on the monitor 308, and for example, they may be provided as “stage (first stage, second stage, third stage) - row (left, middle, right) - position in the trays 2 (1, 2, 3, ... 9)”.

In FIG. 13, positions in the trays 2 where no piece of fried food X is placed is displayed by shading. Based on the notification signal output from the notification unit 46, the pieces of fried food X which have been determined to be disposed by the determination unit 44 of the fried food disposal time management device 4 are displayed in such a manner that the numbers corresponding thereto blink or are displayed with different color on the monitor 308. Furthermore, the method of notifying the time to dispose the fried food X may include, not only visualizing the notification on the screen of the monitor 308 but also sounding a buzzer or the like. In FIG. 13, the numbers provided to the pieces of fried food X which are determined to be disposed are indicated by thick lines.

In the present embodiment, the fried food disposal time management device 4 includes the machine learning unit 47 that generates a learning model capable of determining the time to dispose the fried food X by machine learning. The machine learning unit 47 estimates a determination reference based on the determination result by the determination unit 44, performs machine learning using the estimated determination reference to generate a learning model, and updates the determination reference stored in the storage unit 45 based on the generated learning model. This improves the accuracy of determination result by the determination unit 44.

Specifically, the machine learning unit 47 generates a calibration line (model equation) using reference value data (explanatory variable) already stored in the storage unit 45, for example, by linear regression, support vector machine (SVM), bugging, boosting, AdaBoost, decision tree, random forest, logistic regression, neural network, deep learning, in deep learning, especially a convolution neural network (CNN) and recurrent neural network (RNN), long short-term memory (LSTM), or the like.

As the type of linear regression (analysis), for example, single regression, multiple regression, partial least-squares (PLS) regression, and orthogonal projection partial least squares (OPLS: orthogonal partial least squares) regression have been known. At least one of these types can be selected and used.

Single regression is an approach for predicting one objective variable by one explanatory variable while multiple regression is an approach for predicting one objective variable by a plurality of explanatory variables. The (orthogonal projection) partial least squares regression is an approach for extracting principal components corresponding to small features (obtained by principal component analysis with explanatory variables only) so that the covariance between the principal components and the objective variable is maximized. The (orthogonal projection) partial least squares regression is a suitable approach when the number of explanatory variables is greater than the number of samples and the correlation among explanatory variables is strong.

Applying the calibration curve obtained by the machine learning in the machine learning unit 47 to the color components analyzed in the analysis unit 43 enables estimation of the determination reference value and supply of the result thereof to the determination unit 44.

The machine learning unit 47 may be configured to generate the learning model per user who creates and inputs the data. In this case, in the determination of the time to dispose the fried food X using a learning model, each user uses only the learning model generated based on the data provided by each user themselves. This enables determination of the time to dispose specifically to the environment in the hot showcase 1 of each user.

Furthermore, the machine learning unit 47 may be configured to generate the learning model without distinguishing units of users who create and input data. In this case, the learning model can be generated using a larger amount of data. When the generated learning model is used, the time to dispose the fried food X is determined using the characteristics (for example, type of the fried food X), which are predefined per user unit, and the color components as input data. This enables highly precise determination of time to dispose using a learning model with a larger amount of machine learning based on the environments in the hot showcases 1 of a plurality of users.

Still further, the machine learning unit 47 can generate not only a learning model capable of determining the time to dispose the fried food X but also a learning model capable of identifying the type of fried food X. This enables further improvement in the accuracy of identification of the type of fried food X by the identification unit 42.

As illustrated in FIG. 12, in the fried food disposal time management device 4, firstly, the data acquisition unit 41 acquires surface images of the pieces of fried food X for each of the trays 2 (conditions of the pieces of fried food X being displayed on each of the trays 2) detected and output by each of the cameras 5 in the step of detection (step S401).

Next, the fried food disposal time management device 4 extracts an individual image of each of the pieces of fried food X from each of the surface images acquired in step S401 (step S402), and then the identification unit 42 identifies the type of each of the pieces of fried food X from each of the individual images (step S403; step of identification).

Next, the analysis unit 43 analyzes the color components (RGB values) of each of the pieces of fried food X from each of the individual images extracted in step S402 (step S404). Subsequently, for each of the pieces of fried food X, the determination unit 44 compares the color components thereof analyzed in step S404 with the determination reference values related to the type thereof identified in step S403 so as to determine whether the time to dispose has been reached (step S405; step of determination).

For any piece of fried food X which is determined to be disposed in step S405 (step S405/YES), the notification unit 46 outputs, to the monitor 308, a notification signal for notifying that the time to dispose thereof is reached (step S406). Upon receiving the notification signal, the monitor 308 notifies the determination result indicating that the time to dispose is reached (step of notification). On the other hand, for any piece of fried food X which is determined not to be disposed in step S405 (step S405/NO), the flow returns to step S401 and then repeats the processing.

In the present embodiment, when it is determined in step S405 that the time to dispose is reached (step S405/YES), the machine learning unit 47 estimates the determination reference values based on the determination result (step S407). Subsequently, the machine learning unit 47 performs machine learning using the determination reference estimated in step S407 so as to generate a learning model (step S408). Then, the machine learning unit 47 updates the determination reference values stored in the storage unit 45 based on the learning model generated in step S408 (step S409). After the processes in step S406 and in step S409 are executed, the processing in the fried food disposal time management device 4 is ended.

As described above, determining the time to dispose the fried food X being displayed in the hot showcase 1 based on an indicator (in the present embodiment, color tone) indicating the change in the condition with the elapsed time from the finishing of deep-frying thereof enables highly accurate management as compared with the case of manually managing the time to dispose by an employee of the store 31.

In the present embodiment, the fried food disposal time management device 4 acquires the surface images of each of the pieces of fried food X captured by each of the cameras 5 as data related to the color tone thereof. However, the present invention is not limited thereto, and may acquire, for example, data detected by using a color difference meter as the data related to the color tone of each of the pieces of fried food X.

### Second Embodiment

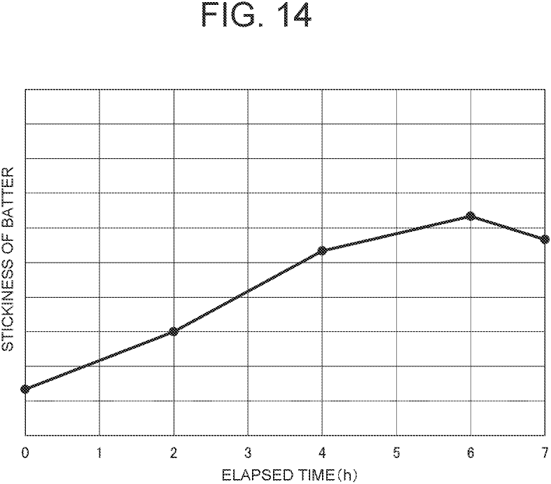

Next, the fried food disposal time management device 4 according to a second embodiment will be described with reference to FIGS. 14 to 20.

The fried food disposal time management device 4 according to the first embodiment determines the time to dispose the fried food X using the color tone (color components) thereof as an indicator. In the present embodiment, the case of using other indicators each indicating the condition of the fried food X will be described.

FIG. 14 is a graph illustrating the change in the stickiness of fried food batter, which is obtained by sensory evaluation, with respect to the elapsed time. In FIG. 14, the horizontal axis represents the elapsed time after the finishing of deep-frying of a fried food to be evaluated, and the vertical axis represents a value obtained by indexing the “stickiness of batter” of the fried food.

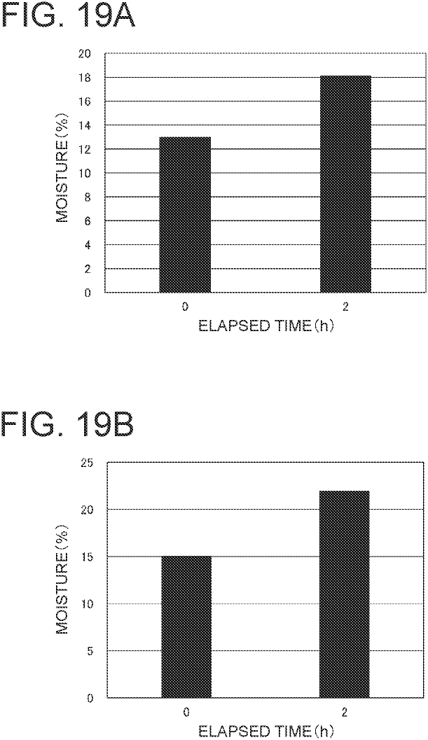

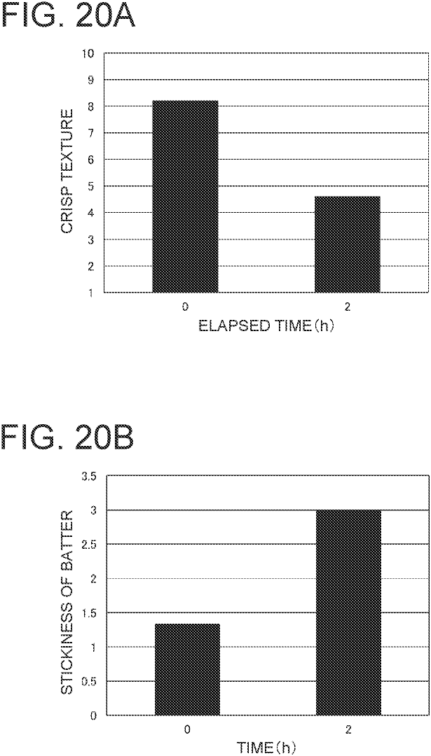

As illustrated in FIG. 14, in the case of a fried food, the more the time passes after the finishing of deep-frying thereof, the more the value of the indicator indicating the stickiness of batter increases. That is, the batter of the fried food tends to become sticky over time. This “stickiness of batter” is caused by the moisture content in the fried food batter, and as the moisture content increases, the batter becomes stickier. Here, FIG. 19A is a graph illustrating the temporal change in the moisture content in batter on a front surface of a fried chicken being displayed in the hot showcase 1, and FIG. 19B is a graph illustrating the temporal change in the moisture content in batter on a back surface of the fried chicken being displayed in the hot showcase 1. Note that the “back surface” of the fried chicken is a surface in contact with the tray 2, and the “front surface ” is an opposite surface thereof, in other words, an upper side of the fried chicken being displayed in the hot showcase 1. As illustrated in FIG. 19A and FIG. 19B, in both the batter on the front surface and that on the back surface of the fried chicken being displayed in the hot showcase 1, the more the time passes, the more the content (%) of the moisture increases (for example, in FIG. 19A and FIG. 19B, elapsed time=2 hours) as compared with the content obtained immediately after the finishing of deep-frying thereof (in FIG. 19A and FIG. 19B, elapsed time=0 hours). FIG. 20A is a graph illustrating the temporal change in the crisp texture of a fried chicken being displayed in the hot showcase 1, and FIG. 20B is a graph illustrating the temporal change in the stickiness of batter of the fried chicken being displayed in the hot showcase 1. The crisp texture illustrated in FIG. 20A tends to increase as the score of the sensory evaluation indicated on the vertical axis is high, and similarly to the stickiness of batter illustrated in FIG. 14, the stickiness of batter illustrated in FIG. 20B tends to increase as the score of the sensory evaluation indicated on the vertical axis is high. As illustrated in FIG. 20A, in the case of the fried chicken being displayed in the hot showcase 1, the more the time passes (in FIG. 20A, elapsed time=2 hours) after the finishing of deep-frying thereof (elapsed time=0 hours), the more the value of the indicator indicating the crispy texture of batter decreases. On the other hand, as illustrated in FIG. 20B, in the case of the fried chicken being displayed in the hot showcase 1, the more the time passes (in FIG. 20B, elapsed time=2 hours) after the finishing of deep-frying thereof (elapsed time=0 hours), the value of the indicator indicating the stickiness of batter increases. That is, the fried chicken batter becomes less crisp but becomes sticky as the time passes after the finishing of deep-frying thereof. As described above, since the moisture content in the fried chicken batter increases as the time passes after the finishing of deep-frying, it can be considered that both the decrease in the crispy texture and increase in the stickiness are caused by the moisture content in the fried chicken batter.

Here, a value of the “deteriorated flavor” illustrated in FIG. 2 also increases as the time passes. Thus, there is a correlation between the increase in the moisture content in the batter and the deterioration of flavor of the fried food. In view of the above, the fried food disposal time management device 4 can use the moisture content in batter of the fried food X being displayed in the hot showcase 1 as an indicator indicating the condition of the fried food X so as to determine whether the time to dispose the fried food X is reached based on the change in the moisture content in the batter of the fried food X.

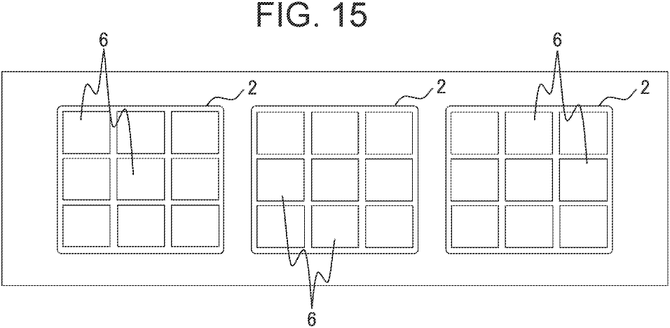

FIG. 15 is a plan view of a bottom surface of a certain stage in the hot showcase 1 as viewed from above.

In order to measure the moisture content of the fried food X being displayed in the hot showcase 1, for example, a moisture content measurement sensor 6 having the mat shape illustrated in FIG. 15 is used. The moisture content measurement sensor 6 may be a sensor that detects the weight of the fried food X to measure the moisture content, or may be a sensor that detects the change in the dielectric constant to measure the moisture content.

The moisture content measurement sensors 6 are mounted in the hot showcase 1 so as to correspond to the positions of the pieces of fried food X being displayed, respectively. In FIG. 15, the nine moisture content measurement sensors 6 are arrayed in a matrix in each of the trays 2, whereby, in each of the trays 2, up to nine pieces of fried food X are to be displayed at a time and the water content of each of the nine pieces of fried food X can be individually measured. Note that, in the case where a plurality of pieces of fried food X are arranged in a measurable range of one moisture content measurement sensor 6, and when the moisture content measurement sensor 6 can measure the weight of each of them, the number of moisture content measurement sensors 6 and the arrangement positions thereof may not be limited.

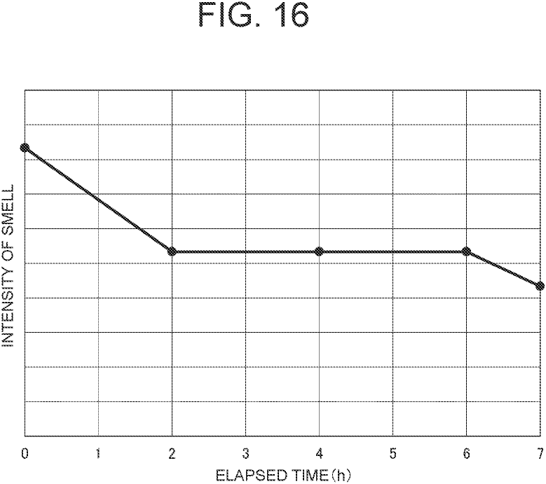

FIG. 16 is a graph illustrating the change in the intensity of the smell of a fried food, which is obtained by sensory evaluation, with respect to the elapsed time. In FIG. 16, the horizontal axis represents the elapsed time from the finishing of deep-frying of a fried food to be evaluated, and the vertical axis represents a value obtained by indexing the “intensity of smell” of the fried food.

Here, the “smell” may generally mean both the favorable smell and unfavorable smell of a fried food. Hereinafter, the favorable smell of a fried food is referred to as “good smell”, and the unfavorable smell thereof is referred to as “bad smell”. FIG. 16 illustrates the temporal change in the smell (smell as a whole that are not distinct between good smell and bad smell) including good smell and bad smell.

As illustrated in FIG. 16, in the case of a fried food, the more the time passes from the finishing of deep-frying thereof, the more the intensity of the smell, which is an indicator indicating how strong the smell is, decreases. That is, the smell of a fried food tends to decrease over time. This means that decrease in the whole of volatile components of the fried food. During the decrease in the intensity of the smell of the fried food, the balance between the good smell and the bad smell changes. Increase in the occurrence ratio of the substance such as Aldehyde or Ketone which causes the bad smell, in other words, change in the volatile component composition makes people smell bad from the fried food. Note that deterioration of edible oil used for deep-frying of a fried food and decomposition of fatty acids contained in the edible oil causes occurrence of the substance such as Aldehyde or Ketone.

Here, a value of the “deteriorated flavor” illustrated in FIG. 2 also increases as the time passes. It is commonly known that the flavor of a fried food deteriorates as the intensity of the smell of the fried food decreases and the ratio of the bad smell increases. Thus, there is a correlation between the decrease in the volatile components of the fried food or the increase in the ratio of the substance such as Aldehyde or ketone due to the change in the volatile component composition of the fried food and the deterioration of flavor of the fried food. In view of the above, the fried food disposal time management device 4 can use the volatile components or volatile component composition of the fried food X being displayed in the hot showcase 1 as an indicator indicating the condition of the fried food X so as to determine whether the time to dispose the fried food X is reached based on the change in the volatile components or volatile component composition of the fried food X.

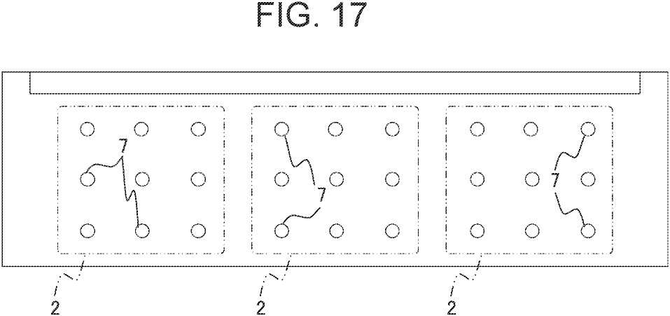

FIG. 17 is a top view of a portion corresponding to a top face of a certain stage in the hot showcase 1 as viewed from below, which illustrates a plurality of smell sensors 7 attached to the top face portion. In FIG. 17, the outer frame of each of the trays 2 is indicated by a two-dot chain line.

As illustrated in FIG. 17, the smell sensors 7 for detecting the smell generated from the fried food X are attached above each of the trays 2 on which the pieces of fried food X are placed, in other words, a portion corresponding to the top face with respect to each of the floors 11, 12, 13. In the same manner as the moisture content measurement sensors 6, the smell sensors 7 are installed so as to correspond to the positions of the pieces of fried food X being displayed in the hot showcase 1, respectively, whereby the smell sensors 7 and each of the pieces of fried food X have a positional relationship allowing detection of the smell of each of the pieces of fried food X.

Each of the smell sensors 7 may be a sensor capable of detecting both the good smell and bad smell (smell) of the fried food X, may be a sensor capable of detecting the good smell of the fried food X, or may be a sensor capable of detecting the bad smell of the fried food X. For example, in the case of using the smell sensors 7 for detecting the bad smell of the fried food X, the fried food disposal time management device 4 uses the smell including a component such as Aldehyde system or Ketone as a determination indicator to determine the time to dispose the fried food. In the relationship between the elapsed time from the finishing of deep-frying of the fried food X and the intensity of the bad smell, the intensity of the bad smell tends to increase as the time passes from the finishing of deep-frying of the fried food X, which is opposite to the tendency in the good smell.

The sensor specifications of the smell sensors 7 are not particularly limited. For example, the sensors such as crystal resonator smell sensors including sensitive films made of organic thin films and crystal resonators, semiconductor gas sensor that detect the gas concentration based on the change in resistance values of oxide semiconductors due to adsorption of gas molecules on the oxide semiconductors, infrared gas sensors, electrochemical gas sensors, contact combustion gas sensors, biosensors, or the like can be used.

In addition to the indicators described above, the fried food disposal time management device 4 may use an indicator indicating the condition of the fried food X being displayed in the hot showcase 1 such as the acid value, anisidine value, carbonyl value, iodine value, polar compound value, iodine value, amount of polar compounds, amount of volatile components, volatile component composition, or size thereof so as to determine whether the time to dispose the fried food X is reached based on the change in the acid value, anisidine value, carbonyl value, peroxide value, iodine value, amount of polar compounds, amount of volatile components, volatile component composition, or size thereof.

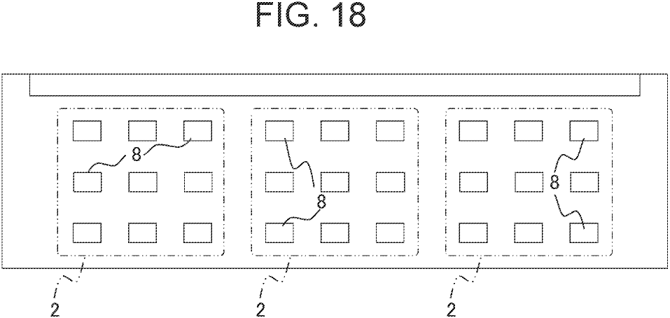

FIG. 18 is a top view of a portion corresponding to a top face of a certain stage in the hot showcase 1 as viewed from below, which illustrates a plurality of near-infrared sensors 8 attached to the top face portion.

Using the near-infrared sensors 8 enables detection of the acid value, anisidine value, carbonyl value, peroxide value, iodine value, and amount of polar compounds of the fried food X. Each of the near-infrared sensors 8 is configured to reflect the near-infrared light to the fried food X to detect the change in the absorption rate of a specific wavelength based on the moisture content or the content of components in the fried food X, thereby measuring the acid value, anisidine value, carbonyl value, peroxide value, iodine value, and amount of polar compounds, as well as the water content of the fried food X.

In the same manner as the moisture content measurement sensors 6 and the smell sensors 7, the near-infrared sensors 8 are installed so as to correspond to the positions of the pieces of fried food X being displayed in the hot showcase 1, whereby the near-infrared sensors 8 and each of the pieces of fried food X have a positional relationship allowing detection of the acid value and the like of each of the pieces of fried food X.

In the case of using the size of each of the pieces of fried food X as an indicator, using images captured by the cameras 5 (see the first embodiment) enables measurement thereof. It is known that the size of a fried food decreases as the time passes from the finishing of deep-frying thereof.

### Third Embodiment

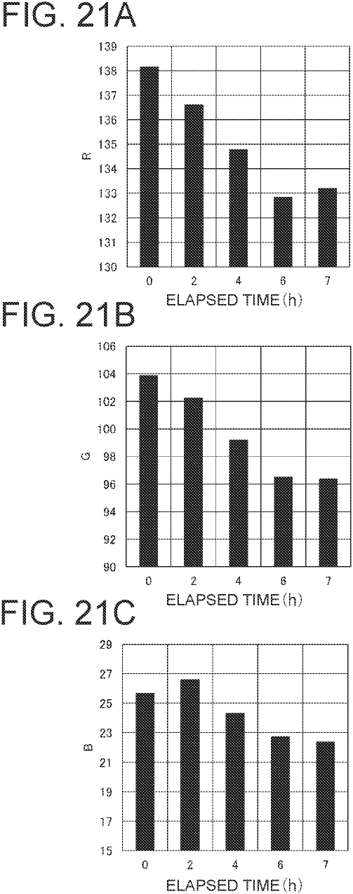

Next, the fried food disposal time management device 4 according to a third embodiment will be described with reference to FIG. 21A to FIG. 21C.

In the first embodiment, an example of an experimental result of color component analysis based on the images (still images or moving images) of an exemplary fried chicken and croquette each of which is an aspect of the fried food X has been described. In the present embodiment, an example of an experimental result of color component analysis based on the still images of an exemplary hash brown which is one of other aspects of the fried food X will be described.

FIGS. 21A to 21C are graphs illustrating the change in color components, which are obtained by capturing still images of a hash brown being displayed in the hot showcase 1 and analyzing the captured still images, with respect to the elapsed time. FIG. 21A illustrates the trends of the component R with respect to the elapsed time, FIG. 21B illustrates the trends of the component G with respect to the elapsed time, and FIG. 21C illustrates the trends of the component B with respect to the elapsed time.

Based on the analysis of the color components from the still images of the hash brown being displayed in the hot showcase 1, after two hours (=2 h) from the finishing of deep-frying thereof (=0 h), the components R and G decrease while the component B increases. Furthermore, the component R decreases as four hours and then six hours pass from the finishing of deep-frying, and after seven hours, it is found that the component R tends to increase slightly. On the other hand, each of the color components G and B tends to decrease as a whole as four hours, six hours, and seven hours pass from the finishing of deep-frying.

As described above, for hash browns being displayed in the hot showcase 1, in the same manner as fried chickens and croquettes, a reference RGB value which is a reference value for determining the time to dispose thereof can be set in advance based on the tendency of the change in color tone with time elapsed from the finishing of deep-frying. In the case of hash browns, as in the case of fried chickens and croquettes, the change in color tone with the time elapsed can be apparently found after two hours from the finishing of deep-frying.

### Fourth Embodiment

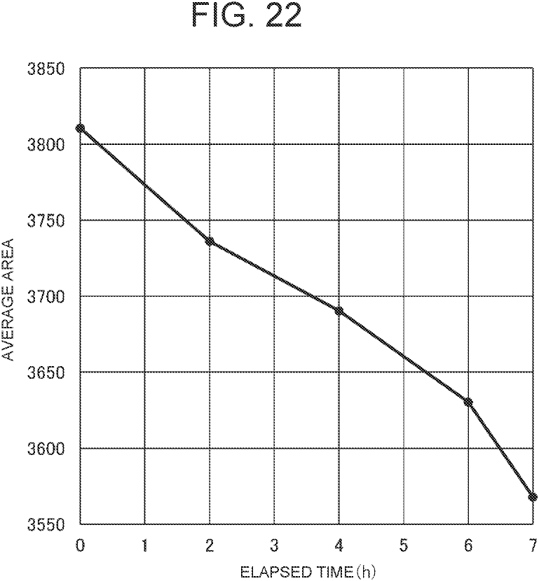

Next, the fried food disposal time management device 4 according to a fourth embodiment will be described with reference to FIG. 22.

In the present embodiment, an example of using an area of the fried food X, in other words, the size of the fried food X as an indicator indicating the condition of the fried food X will be described.

FIG. 22 is a graph illustrating the change in an average area, which is obtained by capturing still images of three pieces of fried chickens being displayed in the hot showcase 1 and analyzing the captured still images, with respect to the elapsed time. In FIG. 22, the horizontal axis represents the elapsed time from the finishing of deep-frying of fried chickens to be evaluated, and the vertical axis represents a value obtained by indexing an “average area” which is an average value of areas of three pieces of fried chickens calculated in the image analysis.

According to the graph illustrated in FIG. 22, in the case of fried chickens, an area (average area), which is an indicator indicating the size thereof, decreases as the time passes from the finishing of deep-frying. That is, a fried chicken tends to decrease in size over time.

Here, a value of the “deteriorated flavor” illustrated in FIG. 2 increases as the time passes. Thus, there is a correlation between the decrease in an area (size) of a fried food and the decrease in the flavor of the fried food. In view of the above, the fried food disposal time management device 4 can use an area of the fried food X being displayed in the hot showcase 1, in other words, the size as an indicator indicating the condition of the fried food X so as to determine whether the time to dispose the fried food X is reached based on the change in the size of the fried food X.

In the above, the present invention has been described with reference to each of the embodiments of the present invention. The present invention is not limited to each of the embodiments described above, but include various modifications. For example, each of the embodiments is described in detail herein for clarity, and the present invention is not necessarily limited to those including all the features described above. Furthermore, some of the features according to a predetermined embodiment can be replaced with other features according to the separate embodiments, and other features can be added to the configuration of a predetermined embodiment. Still further, some of the features can include other features of the separate embodiments, be deleted, and/or replaced.

For example, in the embodiments described above, as an aspect of a display cabinet, the hot showcase 1 provided with the three floors 11, 12, 13 in which the fried food X is displayed has been described. However, the display cabinet does not necessarily have to include a plurality of floors, and for example, a tray or the like may be included. The aspect of the display cabinet is not limited as long as the fried food X can be displayed therein.

### REFERENCE SIGNS LIST

1: hot showcase (display cabinet)
3: fried food disposal time management system
4: fried food disposal time management device
5: camera (condition sensor)
6: moisture content measurement sensor (condition sensor)
7: smell sensor (condition sensor)
41: data acquisition unit
42: identification unit
43: analysis unit
44: determination unit
46: notification unit
47: machine learning unit
308: monitor (notification device)
X: fried food

1. A fried food disposal time management device for managing a time to dispose a fried food to be displayed in a display cabinet, the fried food disposal time management device comprising:
a data acquisition unit that acquires data output from a condition sensor configured to detect a condition of the fried food being displayed in the display cabinet;
a determination unit that determines whether the time to dispose the fried food being displayed in the display cabinet is reached based on the condition of the fried food acquired as the data by the data acquisition unit and a determination reference set in advance as a reference for determining the time to dispose the fried food; and
a notification unit that outputs, when the determination unit makes a determination result that the time to dispose the fried food being displayed in the display cabinet is reached, a notification signal for notifying the determination result to a notification device.

2. The fried food disposal time management device according to claim 1, further comprising a machine learning unit that generates a learning model capable of determining the time to dispose the fried food by machine learning, wherein
the machine learning unit estimates the determination reference based on the determination result by the determination unit, performs the machine learning using the determination reference as estimated to generate the learning model, and updates the determination reference based on the learning model as generated.

3. The fried food disposal time management device according to claim 1, wherein
the data acquired by the data acquisition unit is data related to at least one of indicators including a color tone, size, water content, amount of volatile components, volatile component composition, acid value, anisidine value, carbonyl value, peroxide value, iodine value, and amount of polar compounds of the fried food being displayed in the display cabinet.

4. The fried food disposal time management device according to claim 3, further comprising an analysis unit that analyzes, when the data acquisition unit acquires a surface image of the fried food being displayed in the display cabinet as data related to the color tone, color components of the fried food from the surface image.

5. The fried food disposal time management device according to any one of claim 1, further comprising an identification unit that identifies a type of the fried food being displayed in the display cabinet, wherein
the determination unit determines whether the time to dispose the fried food being displayed in the display cabinet is reached based on the condition of the fried food acquired as the data by the data acquisition unit, the type of the fried food identified by the identification unit, and the determination reference set for each type of the fried food.

6. A fried food disposal time management system for managing a time to dispose a fried food to be displayed in a display cabinet, the fried food disposal time management system comprising:
a condition sensor that detects a condition of the fried food being displayed in the display cabinet;
a fried food disposal time management device that manages the time to dispose the fried food being displayed in the display cabinet; and
a notification device that notifies that the fried food being displayed in the display cabinet needs to be disposed,
the fried food disposal time management device being configured to:
acquire the condition of the fried food output from the condition sensor;
determine whether the time to dispose the fried food being displayed in the display cabinet is reached based on the condition of the fried food as acquired and a determination reference set in advance as a reference for determining the time to dispose the fried food; and
when making a determination result that the time to dispose the fried food being displayed in the display cabinet is reached, output a notification signal for notifying the determination result to the notification device.

7. The fried food disposal time management system according to claim 6, wherein
data detected by the condition sensor is data related to at least one of indicators including a color tone, size, water content, amount of volatile components, volatile component composition, acid value, anisidine value, carbonyl value, peroxide value, iodine value, and amount of polar compounds of the fried food being displayed in the display cabinet, and
the determination reference is a reference value set for each of the indicators.

8. The fried food disposal time management system according to claim 6, wherein
the fried food disposal time management device is configured to:
identify a type of the fried food being displayed in the display cabinet; and
determine whether the time to dispose the fried food being displayed in the display cabinet is reached based on the condition of the fried food as acquired, the type of the fried food as identified, and the determination reference set for each type of the fried food.

9. A fried food disposal time management method for managing a time to dispose a fried food to be displayed in a display cabinet, the fried food disposal time management method comprising:
as a detecting step, detecting a condition of the fried food being displayed in the display cabinet;
as a determining step, determining whether the time to dispose the fried food being displayed in the display cabinet is reached based on the condition of the fried food detected in the step of detecting and a determination reference set in advance as a reference for determining the time to dispose the fried food, and
when a determination result that the time to dispose the fired food being displayed in the display cabinet is reached is made in the determining step, as a notifying step, notifying the determination result.

10. The fried food disposal time management method according to claim 9, wherein,
in the detecting step, data related to at least one of indicators including a color tone, size, water content, amount of volatile components, volatile component composition, acid value, anisidine value, carbonyl value, peroxide value, iodine value, and amount of polar compounds of the fried food being displayed in the display cabinet is detected, and
in the determining step, a reference value set for each of the indicators is used as the determination reference to determine whether the time to dispose the fried food being displayed in the display cabinet is reached.

11. The fried food disposal time management method according to claim 9, further comprising, as an identifying step, identifying a type of the fried food being displayed in the display cabinet, wherein
in the determining step, whether the time to dispose the fried food being displayed in the display cabinet is reached is determined based on the condition of the fried food detected in the detecting step, the type of the fried food identified in the identifying step, and the determination reference set for each type of the fried food.
